(19) United States
(12) Patent Application Publication
(10) Pub. No.: US 2023/0344227 A1
(43) Pub. Date: Oct. 26, 2023

(54) MACHINE LEARNING MODELS FOR POWER OUTPUT PREDICTION

(71) Applicant: STEM, INC., San Francisco, CA (US)

(72) Inventors: Babak ASGHARI, Vancouver (CA); Mahadevan BALASUBRAMANIAM, Brentwood, CA (US)

(21) Appl. No.: 17/730,109

(22) Filed: Apr. 26, 2022

(51) Int. Cl. H02J 3/00; H02J 3/14; G06K 9/62; G06N 20/00

(52) U.S. Cl. CPC H02J 3/004; H02J 3/144; G06K 9/6256; G06N 20/00; H02J 2300/24

(57) ABSTRACT

Embodiments the present invention set forth techniques for generating power output predictions of power generation devices. In some embodiments, the techniques include receiving one or more data samples associated with at least one power generation device, each data sample including a plurality of features; processing a first portion of the plurality of features by a first portion of a machine learning model to generate one or more latent space variables; and processing the one or more latent space variables and a second portion of the plurality of features by a second portion of the machine learning model to generate a predicted power output of the at least one power generation device. The one or more latent space variables and the second portion of the plurality of features are based on physics relationships of the at least one power generation device.

### BACKGROUND

### Field of the Various Embodiments

Embodiments of the present disclosure relate generally to power generation devices, and, more specifically, to machine learning models for power output.

### Description of the Related Art

A photovoltaic device, such as a solar panel, can generate power for delivery to a power grid, storage in a storage device (e.g., a battery), or supply to another device (e.g., a factory machine). However, the power output of a power generation device, such as a photovoltaic device, can vary based on a variety of factors, such as ambient temperature, cloud coverage, solar irradiance, time of day, or the like. The use of the collected power can be adjusted based on the variance in power output resulting from the variance in the factors that affect the operation of the power generation device. As a first example, a factory machine can be scheduled to be online and operating during periods of high predicted power output, and can be scheduled to be offline for maintenance during periods of low predicted power output. As a second example, the factory machine can be scheduled and budgeted to operate on solar power during periods of high predicted power output, and can be scheduled and budgeted to operate on other power sources during periods of low predicted power output. As a third example, accurate predictions of predicted power output can inform predictions of power stored by power storage devices, such as batteries that are connected to the power generator devices. The predictions of power stored by power storage devices can, in turn, inform projections and schedules of power supply, demand, and sharing.

Advances in the field of machine learning and increases in computing power have led to machine learning models that are capable of predicting the output of power generation devices. In particular, data samples can be collected from a set of power generation devices. Each data sample includes a plurality of features of the power generation device and the power output of the power generation device. For example, for a photovoltaic device, the plurality of features can include ambient temperature, cloud coverage (e.g., a fraction of the sky that is covered by clouds), and solar irradiance, which can be collected from an on-site weather station or from a weather service provider for the location of an installed photovoltaic system. That is, the photovoltaic data samples can include photovoltaic device features, such as DC voltage of the photovoltaic panels, meteorological data, and the electric power output of the photovoltaic panels. The data samples can be used as a training data set to train a machine learning model. After training, the trained machine learning model can be applied to a plurality of features of a particular power generation device in order to predict its power output. Trained machine learning models can generate predictions of power output without device-specific information (e.g., panel area and orientation). Also, trained machine learning models can generate predictions of power output without extensive calibration that is required by some physics-based models to account for hardware properties such as the number of panels, efficiency, snow cover, and the like.

One disadvantage with using machine learning models to predict power output is the difficulty of combining machine learning models with physics models of power generation devices. For example, in solar power generation, solar irradiance can be modeled as a global horizontal irradiance (GHI), which can be based on components such as diffuse horizontal irradiance (DHI) and direct normal irradiance (DNI). Each component is affected by features of the solar power generation device, such as ambient temperature, cloud coverage, and a solar zenith angle. Some properties of a power generation device can be represented by physics models, but it can be difficult to design machine learning architectures, such as multilayer perceptrons, that incorporate features of the physics model. For example, it can be difficult to adapt the structure and operations of machine learning architectures to reflect equations that model some properties of the power generation device. As another disadvantage, the training data for machine learning models is often collected from field sensor data that includes noise. As a result, the machine learning models might generate predictions that are consistent with the noisy training data, and might therefore exhibit inaccuracies in predicted power output.

As the foregoing illustrates, what is needed in the art are improved machine learning models for power output prediction.

### SUMMARY

In some embodiments, a computer-implemented method includes receiving a data sample associated with at least one power generation device, the data sample including a plurality of features and a measured power output of the at least one power generation device; processing a first portion of the plurality of features by a first portion of a machine learning model to generate one or more latent space variables; processing the one or more latent space variables and a second portion of the plurality of features by a second portion of the machine learning model to generate a predicted power output of the at least one power generation device; and training the machine learning model based on the measured power output and the predicted power output.

In some embodiments, a computer-implemented method includes receiving one or more data samples associated with at least one power generation device, each data sample including a plurality of features; processing a first portion of the plurality of features by a first portion of a machine learning model to generate one or more latent space variables; and processing the one or more latent space variables and a second portion of the plurality of features by a second portion of the machine learning model to generate a predicted power output of the at least one power generation device.

In some embodiments, a system includes a memory that stores instructions, and a processor that is coupled to the memory and, when executing the instructions, is configured to receive a data sample associated with at least one power generation device, the data sample including a plurality of features; process a first portion of the plurality of features by a first portion of a machine learning model to generate one or more latent space variables; and process one or more latent space variables and a second portion of the plurality of features by a second portion of the machine learning model to generate a predicted power output of the at least one power generation device.

In some embodiments, one or more non-transitory computer-readable media storing instructions that, when executed by one or more processors, cause the one or more processors to perform the steps of receiving a data sample associated with at least one power generation device, the data sample including a plurality of features; processing a first portion of the plurality of features by a first portion of a machine learning model to generate one or more latent space variables; and processing the one or more latent space variables and a second portion of the plurality of features by a second portion of the machine learning model to generate a predicted power output of the at least one power generation device.

At least one technical advantage of the disclosed techniques is the improved accuracy of power output predictions by machine learning models. For example, by processing a latent space variable encoding of a first portion of the plurality of features together with a second portion of the plurality of features, the machine learning model can process the plurality of features based on one or more physics relationships of the power generation device. The power output prediction engine can therefore generate more accurate predictions of power output of the power generation devices. Based on the predicted power output and a measured power output of a power generation device, an alerting system can determine whether the power generation device is operating in a maximum power point generation (MPPG) mode. This determination can trigger diagnostic or maintenance operations to restore the power generation device to a maximum power point generation mode. As another advantage, the machine learning model can generate accurate predictions of predicted power output, which can inform projections and schedules of power supply, demand, and sharing. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a system configured to implement one or more embodiments;

FIG. 2 is an illustration of the machine learning model of FIG. 1, according to one or more embodiments;

FIG. 3 is an illustration of training the machine learning model of FIGS. 1-2, according to one or more embodiments;

FIG. 4 is an illustration of predicting a power output of a power generation device by the machine learning model of FIGS. 1-3, according to one or more embodiments;

FIG. 5 is a flow diagram of method steps for training the machine learning model of FIGS. 1-3 to predict power output of power generation devices, according to one or more embodiments; and

FIG. 6 is a flow diagram of method steps for using the trained machine learning model of FIGS. 1-4 to predict a power output of a power generation device, according to one or more embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

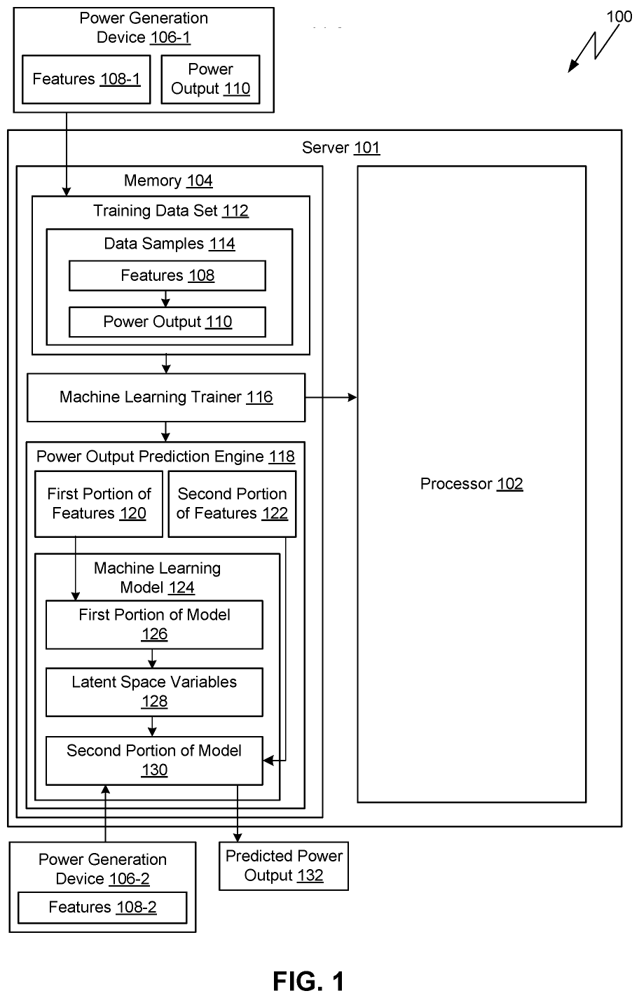

FIG. 1 is a system 100 configured to implement one or more embodiments. As shown, a server 101 within system 100 includes a processor 102 and a memory 104. The memory 104 includes a training data set 112, a machine learning trainer 116, and a power output prediction engine 118. The power output prediction engine 118 includes a machine learning model 124.

As shown, the system 100 receives a plurality of features 108-1 of a power generation device 106-1. As an example, for a photovoltaic device, the plurality of features 108-1 can include ambient temperature, cloud coverage, solar irradiance, time of day, a measured power output 110 of the photovoltaic device, or the like. The plurality of features 108-1 can be based on data received from the power generation device 106-1 and/or from another source, such as an on-site weather station or from a weather service provider for the location of an installed photovoltaic system. The system 100 receives the plurality of features 108-1 from the power generation device 106-1 and generates a training data set 112. The training data set 112 can include a set of data samples 114, each associating some features 108 of the power generation device 106-1 with a measured power output 110. The system 100 can store the plurality of features 108 of the power generation device 106-1 in the training data set 112. In some embodiments, the system 100 receives a plurality of features 108 for each of a plurality of power generation devices 106 and generates a training data set 112 based on the plurality of features 108 of the plurality of power generation devices 106.

As shown, the machine learning trainer 116 is a program stored in the memory 104 and executed by the processor 102 to train the machine learning model 124 of the power output prediction engine 118. The machine learning trainer 116 trains the machine learning model 124 based on the training data set 112. In particular, the machine learning trainer 116 trains the machine learning model 124 to predict, for each data sample 114, a power output based on the plurality of features 108 of the data sample 114. If the measured power output 110 of one of the data samples 114 does not match a predicted power output of the machine learning model 124, the machine learning trainer 116 adjusts one or more parameters of the machine learning model 124 to reduce the difference between the measured and predicted power outputs. The machine learning trainer 116 trains the machine learning model 124 until the predicted power outputs are within an acceptable range of accuracy. The machine learning trainer 116 stores the trained machine learning model 124 (e.g., in a table of a database and/or in a file of a file system). The training of the machine learning model 124 is discussed in greater detail below.

As shown, the power output prediction engine 118 is a program stored in the memory 104 and executed by the processor 102 to generate, for a received a plurality of features 108, a predicted power output 132. In particular, the machine learning model 124 includes a first portion 126 that receives, as input, a first portion 120 of the received a plurality of features 108-2 (e.g., a first subset of the received a plurality of features 108-2). The first portion 126 of the machine learning model 124 generates, as output, one or more latent space variables 128 based on the first portion 120 of the plurality of features 108-2. The machine learning model 124 includes a second portion 130 that receives, as input, the one or more latent space variables 128 and a second portion 122 of the plurality of features 108-2. The second portion 130 of the machine learning model 124 generates, as output, the predicted power output 132 based on the one or more latent space variables 128 and the second portion 122 of the plurality of features 108-2. The power output prediction engine 118 load the machine learning model 124 (e.g., from a table of a database or a file of a file system), processes one or more data samples with the machine learning model 124, and outputs the predicted power output 132 of the power generation device 106-2 based on the received plurality of features 108-2.

Some embodiments of the disclosed techniques include different architectures than as shown in FIG. 1. As a first such example and without limitation, various embodiments include various types of processors 102. In various embodiments, the processor 102 includes a CPU, a GPU, a TPU, an ASIC, or the like. Some embodiments include two or more processors 102 of a same or similar type (e.g., two or more CPUs of the same or similar types). Alternatively or additionally, some embodiments include processors 102 of different types (e.g., two CPUs of different types; one or more CPUs and one or more GPUs or TPUs; or one or more CPUs and one or more FPGAs). In some embodiments, two or more processors 102 perform a part of the disclosed techniques in tandem (e.g., each CPU training the machine learning model 124 over a subset of the training data set 112). Alternatively or additionally, in some embodiments, two or more processors 102 perform different parts of the disclosed techniques (e.g., a first CPU that executes the machine learning trainer 116 to train the machine learning model 124, and a second CPU that executes the power output prediction engine 118 to determine the predicted power outputs 132 of power generation devices 106 using the trained machine learning model 124).

As a second such example and without limitation, various embodiments include various types of memory 104. Some embodiments include two or more memories 104 of a same or similar type (e.g., a Redundant Array of Disks (RAID) array). Alternatively or additionally, some embodiments include two or more memories 104 of different types (e.g., one or more hard disk drives and one or more solid-state storage devices). In some embodiments, two or more memories 104 store a component in a distributed manner (e.g., storing the training data set 112 in a manner that spans two or more memories 104). Alternatively or additionally, in some embodiments, a first memory 104 stores a first component (e.g., the training data set 112) and a second memory 104 stores a second component (e.g., the machine learning trainer 116).

As a third such example and without limitation, some disclosed embodiments include different implementations of the machine learning trainer 116 and/or the power output prediction engine 118. In some embodiments, at least part of the machine learning trainer 116 and/or the power output prediction engine 118 is embodied as a program in a high-level programming language (e.g., C, Java, or Python), including a compiled product thereof. Alternatively or additionally, in some embodiments, at least part of the machine learning trainer 116 and/or the power output prediction engine 118 is embodied in hardware-level instructions (e.g., a firmware that the processor 102 loads and executes). Alternatively or additionally, in some embodiments, at least part of the machine learning trainer 116 and/or the power output prediction engine 118 is a configuration of a hardware circuit (e.g., configurations of the lookup tables within the logic blocks of one or more FPGAs). In some embodiments, the memory 104 includes additional components (e.g., machine learning libraries used by the machine learning trainer 116 and/or the power output prediction engine 118).

As a fourth such example and without limitation, instead of one server 101, some disclosed embodiments include two or more servers 101 that together apply the disclosed techniques. Some embodiments include two or more servers 101 that perform one operation in a distributed manner (e.g., a first server 101 and a second server 101 that respectively train the machine learning model 124 over different parts of the training data set 112). Alternatively or additionally, some embodiments include two or more servers 101 that execute different parts of one operation (e.g., a first server 101 that processes the machine learning model 124, and a second server 101 that translates an output of the machine learning model 124 into a predicted power output 132 for a power generation device 106). Alternatively or additionally, some embodiments include two or more servers 101 that perform different operations (e.g., a first server 101 that trains the machine learning model 124, and a second server 101 that executes the power output prediction engine 118). In some embodiments, two or more servers 101 communicate through a localized connection, such as through a shared bus or a local area network. Alternatively or additionally, in some embodiments, two or more servers 101 communicate through a remote connection, such as the Internet, a virtual private network (VPN), or a public or private cloud.

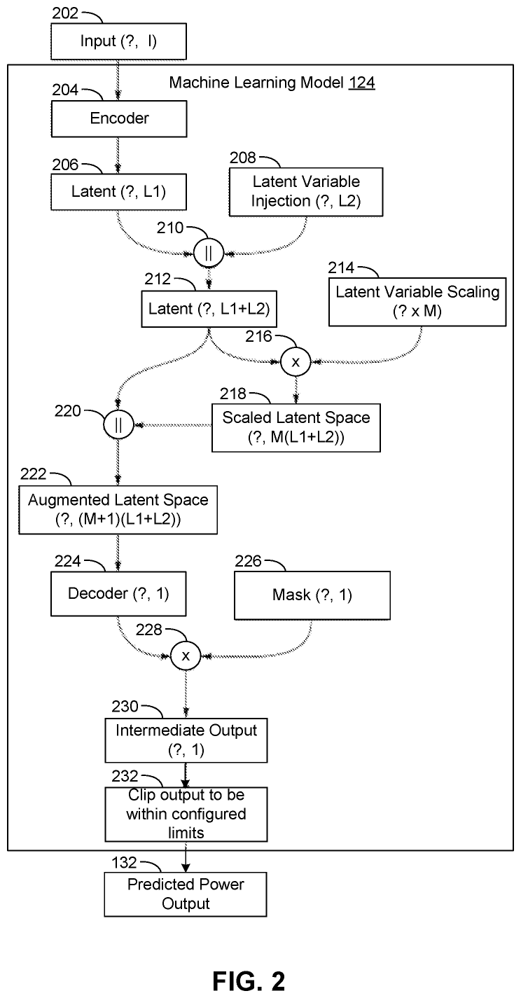

FIG. 2 is an illustration of the machine learning model 124 of FIG. 1, according to one or more embodiments. The machine learning model 124 can be included, for example, in the power output prediction engine 118 stored in the memory 104 of the server 101.

As shown, the machine learning model 124 receives an input 202. The input 202 can include a first portion 120 of the plurality of features 108 of a data sample 114 of a training data set 112. Alternatively, the input 202 can also include a first portion of a plurality of features 108 received from a power generation device 106. In some embodiments, the first portion 120 of the plurality of features 108 includes one or more weather features, such as (without limitation) an ambient temperature parameter and/or a cloud cover parameter. The one or more weather features can indicate the weather at a time of measuring a power output 110 of a power generation device 106 for inclusion in the training data set 112, or the weather at a time associated with a predicted power output 132 of the solar power generation device 106.

In some embodiments, the machine learning trainer 116 normalizes one or more of the plurality of features 108. For example, the machine learning trainer 116 can examine a first feature 108 for each of the data samples 114 of the training data set 112 and determining an average and a standard deviation. For each data sample 114, the machine learning trainer 116 can scale the first feature 108 by subtracting the average from the first feature 108 and dividing the first feature 108 by the standard deviation. The resulting values of the first feature 108 therefore fit a normal distribution across the training data set 112. The machine learning trainer 116 can store a record of the average and the standard deviation for each of the pre-normalized plurality of features 108 for later use by the power output prediction engine 118.

The machine learning model 124 processes the input 202 (more specifically, a first portion 120 of a plurality of features 108 of the input 202) by a first portion of the machine learning model 124. As shown, the first portion 126 of the machine learning model 124 includes an encoder 204. The encoder 204 can include a multilayer perceptron that includes two or more layers, wherein each layer includes one or more neurons. Each layer of the multilayer perceptron receives, as input, either the first portion 120 of the plurality of features 108 or an output of a previous layer of the multilayer perceptron. Each neuron of the layer multiplies each input value by a weight and adds a bias to generate an activation. Each neuron further processes the activation by an activation function to generate an output. In various embodiments, one or more neurons include a nonlinear activation function, such as a rectified linear unit (ReLU) activation function or a hyperbolic tangent (tanh) activation function. The neurons of a next layer of the multilayer perceptron receive the output of the previous layer and process the input by the neurons. The neurons of a final layer of the multilayer perceptron receive the output of the previous layer and generate one or more output values, which are included in the output of the encoder 204. More specifically, the encoder 204 outputs one or more latent space variables 206 that encode the first portion 120 of the plurality of features 108 of the input 202. In some embodiments, the multilayer perceptron outputs the one or more latent space variables 206 with a different dimensionality than the input 202 including the first portion 120 of the plurality of features 108.

The machine learning model 124 receives a second portion 122 of the plurality of features 108 of the input 202. More specifically, the machine learning model 124 receives, as the second portion 122, one or more injected latent space variables 208. In some embodiments, the one or more injected latent space variables 208 include one or more solar insolation parameters, such as (without limitation) a solar zenith parameter indicating a height angle of the sun relative to a local zenith and the horizon, a solar irradiance parameter such as global horizontal irradiance (GHI), a plane of array (POA) irradiance, or the like. The one or more injected latent space variables 208 can indicate the direct exposure of a solar power generation device 106 to the sun at a time of measuring a power output 110 of the power generation device 106 for inclusion in the training data set 112, or the direct exposure of a solar power generation device 106 to the sun at a time associated with a predicted power output 132 of the solar power generation device 106.

The machine learning model 124 applies a first combining operation 210 to the one or more latent space variables 206 and the one or more injected latent space variables 208. The first combining operation 210 produces one or more combined latent space variables 212 including the one or more encoded latent space variables 206 and the one or more injected latent space variables 208. In some embodiments, the first combining operation 210 includes an outer product of at least one of the one or more latent space variables 206 and at least one of the one or more injected latent space variables 208. Alternatively or additionally, in some embodiments, the one or more latent space variables 206 include a first vector, the one or more injected latent space variables 208 include a second vector, and the machine learning model 124 includes a concatenation layer that concatenates the first vector and the second vector to generate a third vector included in the one or more combined latent space variables 212.

In some embodiments, the machine learning model 124 scales, by a scaling parameter 214, one or both of the one or more latent space variables 206 and the second portion 122 of the plurality of features 108. In some embodiments, the machine learning model 124 applies a scaling operation 216 to scale the one or more combined latent space variables 212 by the scaling parameter 214. The scaling operation 216 outputs one or more scaled combined latent space variables 218. In some embodiments, the scaling parameter 214 is a variable selected for scaling the one or more combined latent space variables 212. The scaling parameter 214 can be a hyperparameter of the machine learning model 124. In some embodiments, the scaling parameter 214 is a constant, and the scaling operation 214 multiplies a third vector included in the one or more combined latent space variable 212 by the constant to generate the one or more scaled combined latent space variables 218.

In some embodiments, the machine learning model 124 inputs, to the second portion 130 of the machine learning model 124, a concatenation of (a) one or both of the one or more latent space variables 206 or the second portion 122 of the plurality of features 108 and (b) the scaled one or both of the one or more latent space variables 206 or the second portion 122 of the plurality of features 108. As shown, the machine learning model 124 applies a second combining operation 220 to combine the one or more combined latent space variables 212 generated by a first concatenation operation and the one or more scaled combined latent space variables 218 generated by the scaling operation 216. The second combining operation 220 produces one or more augmented latent space variables 222. In some embodiments, the one or more combined latent space variables 212 include a third vector, the one or more scaled combined latent space variables 218 include a fourth vector, and the second combining operation 220 includes a concatenation layer that concatenates the one or more combined latent space variables 212 and the one or more scaled combined latent space variables 218 to generate a fifth vector included in the one or more augmented latent space variables 222.

In some embodiments, one or both of the one or more latent space variables 206 or the second portion 122 of the plurality of features can be based on one or more physics relationships of the power generation device. For example, the one or more weather features are associated with a diffuse horizontal irradiance (DHI) feature of one or more solar irradiance parameters of a power generation device 106. Consequently, one or more latent space variables 206 represent a latent space encoding of the weather features indicated by the first portion 120 of the plurality of features 108 of the power generation device 106. The one or more injected latent space variables 208 are associated with one or both of the diffuse horizontal irradiance (DHI) solar irradiance feature or a direct normal irradiance (DNI) feature of the one or more solar irradiance parameters of a power generation device 106. The one or more physics relationships can include a determination of a global horizontal irradiance (GHI) of a solar power generation device 106, wherein the global horizontal irradiance is based on a combination of the diffuse horizontal irradiance and the direct normal irradiance. Specifically, the one or more physics relationships can include the following equation:

GHI=DHI+DNI*cos(Z), EQ. 1:

wherein,
GHI represents the global horizontal irradiance of the solar power generation device 106,
DHI represents the diffuse horizontal irradiance based on one or more weather features of the solar power generation device 106,
DNI represents the direct normal irradiance based on one or more solar insolation parameters of the solar power generation device 106, and
Z represents the solar zenith angle of the solar power generation device 106. Based on EQ. 1, the one or more augmented latent space variables 222 can include an encoded representation of the global horizontal irradiance of the power generation device 106.

The machine learning model 124 inputs, to a second portion 130 of the machine learning model 124, a concatenation of the one or more latent space variables 212 and the second portion 122 of the plurality of features 108. As shown, the machine learning model 124 processes the one or more augmented latent space variables 222 by a second portion of the machine learning model 124. As shown, the second portion 130 of the machine learning model 124 includes a decoder 224. For example, the decoder 224 can include a multilayer perceptron that includes two or more layers, wherein each layer includes one or more neurons. Each layer of the multilayer perceptron receives, as input, either the one or more augmented latent space variables 222 or an output of a previous layer of the multilayer perceptron. Each neuron of the layer multiplies each input value by a weight and adds a bias to generate an activation. Each neuron further processes the activation by an activation function (e.g., a ReLU activation function, a tanh activation function, or the like) to generate an output. The neurons of a next layer of the multilayer perceptron receive the output of the previous layer and process the input by the neurons. The neurons of a final layer of the multilayer perceptron receive the output of the previous layer and generate one or more output values, which are included in the output of the decoder 224. In some embodiments, the decoder 224 outputs decoded representation of the predicted power output of EQ. 1.

In some cases, due to tare loss, solar inverters can incorrectly indicate that solar panels generate power output during the evening. If the training data set includes samples that exhibit incorrect power output tare loss, machine learning models that are trained on the data set could exhibit similarly incorrect positive power output predictions during the evening. Thus, in some embodiments, the machine learning model 124 masks an output of the second portion 130 of the machine learning model 124 based on a mask parameter 226. For example, the mask parameter 226 can be based on a time of day associated with the plurality of features. As another example, the mask parameter 226 can be based on a solar irradiance feature (e.g., zero when the solar irradiance feature is zero, and one when the solar irradiance feature is nonzero). In some embodiments, the machine learning model 124 includes a mask operation 228 to be applied to the output of the decoder 224 to generate an intermediate output 230. The mask operation 228 can include a mask parameter 226. For example, the mask parameter 226 can be based on a time of day associated with the plurality of features 108 of the power generation device 106, and the mask operation 228 can multiply the output of the decoder 224 by the mask parameter 226. When the time of day indicates daytime, the masking parameter can be the value 1 (e.g., a unity multiplier), and the mask operation 228 can pass the output of the decoder 224 through as the intermediate output 230 without modification. When the time of day indicates nighttime, the masking parameter can be the value 0 (e.g., a zero multiplier), and the mask operation 228 can output zero for the intermediate output 230. The mask parameter 226 can reduce the occurrence of incorrect nonzero output of the machine learning model 124 for the plurality of features 108 that are associated with nighttime. The mask parameter 226 adds a nonlinear feature to the machine learning model 124 that reduces the predicted power output 132 of the machine learning model 124 to zero for a plurality of features 108 that are associated with nighttime.

In some embodiments, the machine learning model 124 clips an output of the second portion 130 of the machine learning model 124 based on a clipping parameter, wherein the clipping parameter is based on a power output maximum and/or minimum. For example, in some cases, the machine learning model 124 could output a predicted power output 132 that exceeds a maximum power output of the power generation device 106 in a maximum power point generation (MPPG) mode. As another example, in some cases, the machine learning model 124 could output a negative predicted power output 132, when in fact the power output of a power generation device 106 cannot be negative. Thus, the machine learning model 124 includes a clipping operation 232 in which the output is clipped to be within configured limits. The clipping operation 232 can be based on a clipping parameter. For example, the clipping parameter can include a maximum predicted power output of the power generation device 106, such as a power output of the power generation device 106 in a maximum power point generation (MPPG) mode. Clipping the intermediate output 230 generated by the mask operation 228 can limit the clipped output of the machine learning model 124 to the maximum power output of the power generation device 106 in a maximum power point generation (MPPG) mode. Alternatively or additionally, the clipping parameter can include a minimum predicted power output of the power generation device 106, such as zero. Clipping the intermediate output 230 generated by the mask operation 228 can limit the clipped output of the machine learning model 124 to a minimum predicted power output of zero.

In various embodiments, the machine learning model 124 includes a different architecture than as shown in FIG. 2 and as described with respect to FIG. 2. For example (without limitation), one or both of the encoder 204 or the decoder 224 can include architectures other than multilayer perceptrons, such as a Bayesian encoder or a Gaussian mixture model. The encoder 204 can generate encodings of latent space variables with varying sizes, such as varying vector lengths. The decoder 224 can receive encoded latent space variables with varying sizes, such as varying vector lengths. One or more of the operations, including the first combining operation 210, the scaling operation 216, the second combining operation 220, the mask operation 228, and/or the clipping operation 232 can include a variety of operations, such as addition, averaging, maximizing, minimizing, or rounding. The scaling operation 216 and/or the mask operation 228 can be applied to a combination of the latent space variables or a subset of the latent space variables, such as scaling latent space variables associated with direct normal irradiance and not scaling other latent space variables associated with diffuse horizontal irradiance. The combined latent space variables can be based on one or more physics relationships, including physics relationships that are not based on EQ. 1.

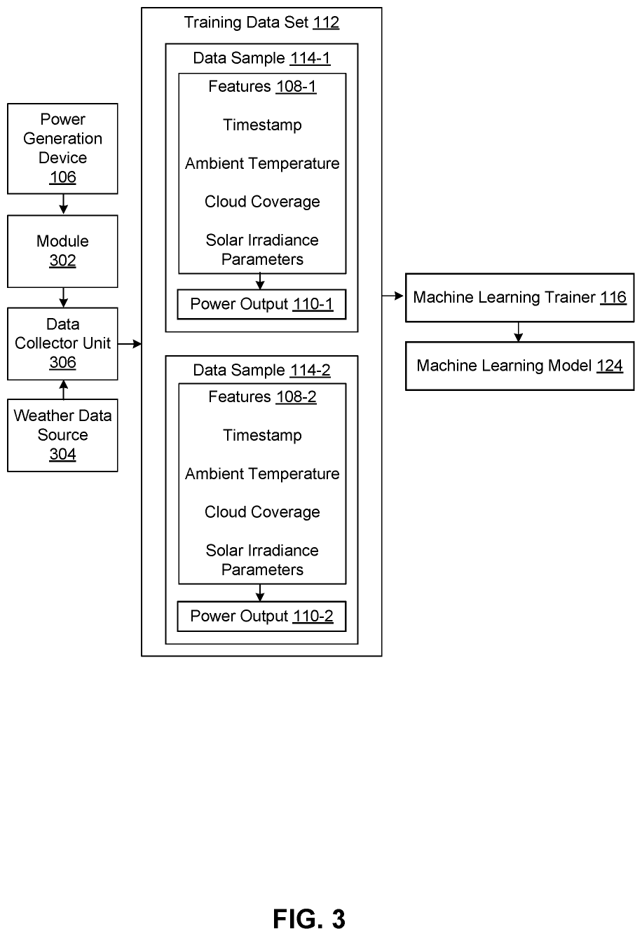

FIG. 3 is an illustration of training the machine learning model of FIGS. 1-2, according to one or more embodiments. The training can be, for example, an operation of the machine learning trainer 116 of FIG. 1.

As shown, one or more power modules 302 transmit data from one or more power generation devices 106 to a data collector unit 306. As shown, the power generation device 106 is a photovoltaic device and the collected data includes photovoltaic data. However, the concepts illustrated in FIG. 3 could be applied to other types of power generation devices 106 and features, such as wind power generation devices, hydroelectric power generation devices, geothermal power generation devices, or the like.

One or more weather data sources 304 transmit data about weather conditions to the data collector unit 306. The data collector unit 306 generates a training data set 112 including data samples 114-1, 114-2, each data sample 114 including a plurality of features 108-1, 108-2 for one of the power generation devices 106 and a measured power output 110-1, 110-2 associated with the plurality of features 108-1, 108-2 of the data sample 114-1, 114-2. For example, the plurality of features 108-1, 108-2 for each data sample 114-1, 114-2 can include a timestamp. The plurality of features 108-1, 108-2 can include a weather feature (e.g., ambient temperature). The plurality of features 108-1, 108-2 for each data sample 114-1, 114-2 can include a cloud coverage feature (e.g., a fraction of the sky that is covered by clouds). The plurality of features 108 for each data sample 114-1, 114-2 can include solar irradiance features (e.g., a solar zenith angle as a measurement of the position of the sun relative to a solar zenith). Each data sample 114-1, 114-2 can include a measured power output 110-1, 110-2 (e.g., a measurement of the power output generated by the one of the power generation devices 106-1 during a period of a data sample collection). In some embodiments, the data collector unit 306 stores each of the data samples 114-1, 114-2 as a multidimensional vector.

The training data set 112 includes the plurality of features 108-1, 108-2 received from the data collector unit 306 from one or more power generation devices 106. Each data sample 114-1, 114-2 associates plurality of features 108-1, 108-2 of each power generation device 106 with a power output 110-1, 110-2. The power output can be, for example, a measurement of output voltage, output current, output power, or the like. The one or more other power generation device 106 can be of a same or similar types, or of different types. In some embodiments, the training data set 112 includes an identifier of the particular power generation device 106 that provided each data sample 114.

In some embodiments, the power output prediction engine 118 normalizes one or more of the plurality of features 108 of the data sample 114. For example, for a first feature of the plurality of features 108, the power output prediction engine 118 can determine and/or retrieve a record of an average and a standard deviation of the first feature within the data samples 114 of the training data set 112. The power output prediction engine 118 can scale the first feature 108 of the data sample 114 by subtracting the average from the first feature 108 and dividing the first feature 108 by the standard deviation.

In some embodiments and as shown in FIG. 2, the machine learning model 124 includes a first portion 126 (e.g., an encoder 204) and a second portion 130 (e.g., a decoder 224). One or both of the first portion 126 or the second portion 130 can include an artificial neural network including a series of layers of neurons (e.g., a multilayer perceptron). The neurons of each layer are at least partly connected to, and receive input from, an input source and/or one or more neurons of a previous layer. Each neuron can multiply each input by a weight; process a sum of the weighted inputs using an activation function; and provide an output of the activation function as the output of the artificial neural network and/or as input to a next layer of the artificial neural network. In various embodiments, the machine learning trainer 116 uses a variety of hyperparameters for choosing a neuron architecture of the machine learning model 124 and/or a training regimen. The hyperparameters can include, for example (without limitation), a machine learning model type, a machine learning model parameter such as a number of neurons or neuron layers, an activation function used by one or more neurons, a loss function to evaluate the performance of the machine learning model 124 during training, and/or a learning rate to be used by the machine learning trainer 116 to update the weights and/or biases of the machine learning model 124. The machine learning trainer 116 can select the hyperparameters through various techniques, such as a hyperparameter search process, a Bayesian hyperparameter optimization process, or a recipe.

The machine learning trainer 116 trains the machine learning model 124 using the training data set 112 to predict the power outputs 110-1, 110-2 of power generation devices 106 based on the plurality of features 108-2 of each data sample 114-1, 114-2. In some embodiments, the machine learning trainer 116 processes each of the data samples 114-1, 114-2 of the training data set 112 by the machine learning model 124 to generate a predicted power output 132. If the measured power output 110-1, 110-2 stored in the data sample 114-1, 1140-2 does not match the predicted power output 132 generated by the machine learning model 124, the machine learning trainer 116 adjusts the parameters of the machine learning model 124 to reduce the difference. The machine learning trainer 116 can repeat this parameter adjustment process over the course of training until the predicted power output 132 for each data sample 114-1, 114-2 is sufficiently close to or matches the measured power outputs 110-1, 110-2 of the data sample 114-1, 114-2. In various embodiments, during training, the machine learning trainer 116 monitors a performance metric, such as a loss function that indicates the correspondence between the measured power outputs 110-1, 110-2 stored in the data samples 114-1, 114-2 and the predicted power outputs 132 for each of the data samples 114-1, 114-2. The machine learning trainer 116 trains the machine learning model 124 through one or more epochs until the performance metric indicates that the correspondence of the measured power outputs 110-1, 110-2 of the data samples 114-1, 114-2 of the training data set 112 and the predicted power outputs 132 are within an acceptable range of accuracy (e.g., until a loss function is below a loss function threshold) or until a designated number of training epochs are completed.

In various embodiments, the machine learning trainer 116 retrains the machine learning model 124. As a first example, the machine learning trainer 116 retrains the machine learning model 124 based on one or more updated data samples 114. In various embodiments, the machine learning trainer 116 retrains the machine learning model 124 periodically (e.g., once per hour) in response to receiving updated data samples 114, such as measurements from one or more power generation devices 106 and/or updated information from a weather data source 304. An update of the training data set 112 can include updated data samples 114 indicating the power output 110 of one or more power generation devices 106 based on new sets of features 108, e.g., new or previously underrepresented weather conditions. The machine learning trainer 116 can add the updated data samples 114 to the training data set 112. The machine learning trainer 116 can also continue training and/or initiate a retraining of the machine learning model 124 based on the updated training data set 112.

Alternatively or additionally, in some embodiments, the machine learning trainer 116 retrains the machine learning model 124 based on machine learning model optimizations and/or training techniques. For example, in some embodiments, the machine learning trainer 116 evaluates or reevaluates an architecture of the machine learning model 124, such as different types of machine learning models. Alternatively or additionally, in some embodiments, the machine learning trainer 116 evaluates or reevaluates values of one or more hyperparameters of the architecture and/or training of the machine learning model 124, such as layer counts, layer sizes, layer types, loss functions, or the like. In some embodiments, the machine learning trainer 116 evaluates the set of available architectures and/or hyperparameters based on a Bayesian hyperparameter optimization technique. Based on the evaluation or reevaluation of the machine learning model 124, the machine learning trainer 116 determines whether to update the architecture and/or hyperparameters of the machine learning model 124. The machine learning trainer 116 can update the architecture and/or hyperparameters of the machine learning model 124 based on an updated configuration of one or both of the first portion 126 of the machine learning model 124 or the second portion 130 of the machine learning model 124. The machine learning trainer 116 can also continue training and/or initiate a retraining of the machine learning model 124 based on the updated architecture and/or hyperparameters of the machine learning model 124, and/or can replace the machine learning model 124 with a newly trained replacement machine learning model 124.

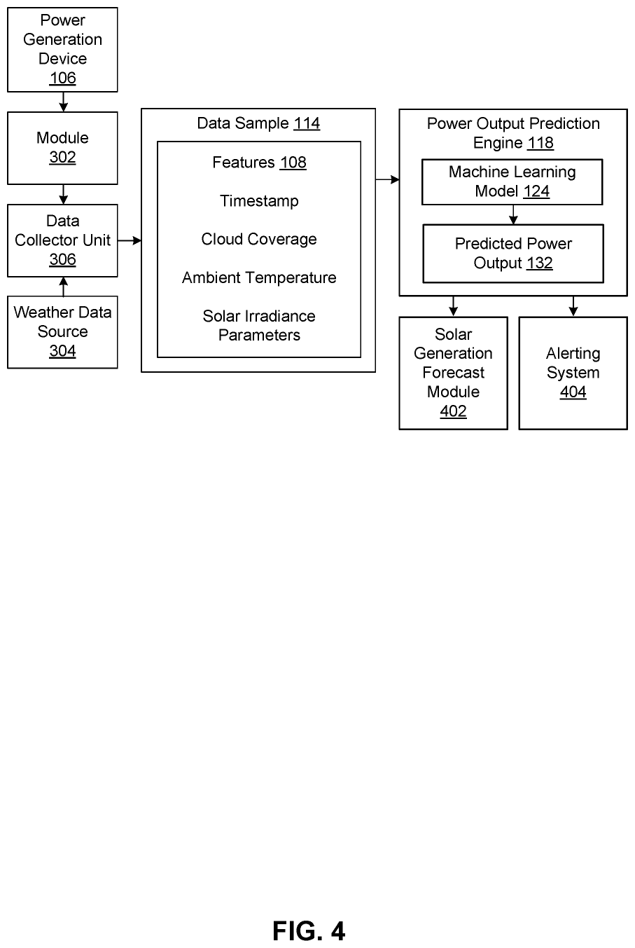

FIG. 4 is an illustration of predicting a power output of a power generation device by the machine learning model of FIGS. 1-3, according to one or more embodiments. The predicting can be, for example, an operation of the power output prediction engine 118 of FIG. 1.

As shown, one or more power modules 302 transmit data from a power generation device 106 to a data collector unit 306. As shown, the power generation device 106 is a photovoltaic device and the collected data includes photovoltaic data. However, the concepts illustrated in FIG. 4 could be applied to other types of power generation devices 106 and features, such as wind power devices, hydroelectric power devices, geothermal power devices, or the like.

One or more weather data sources 304 transmit data about weather conditions to the data collector unit 306. In some embodiments, the one or more weather data sources 304 transmit predictions of weather conditions for a prediction horizon. The data collector unit 306 generates a data sample 114 including a set of features 108 for the power generation device 106. For example, the plurality of features 108 can include a timestamp. The plurality of features 108 can include a weather feature (e.g., ambient temperature). The plurality of features 108 can include a cloud coverage feature (e.g., a fraction of the sky that is covered by clouds). The plurality of features 108 can include solar irradiance features (e.g., a solar zenith angle as a measurement of the position of the sun relative to a solar zenith). In some embodiments, the data collector unit 306 stores the data sample 114 as a multidimensional vector.

A power output prediction engine 118 receives the data sample 114 and provides the data sample 114 as input to a machine learning model 124. The power output prediction engine 118 receives the output of the machine learning model 124 and generates a predicted power output 132 of the power generation device 106. In some embodiments, the power output prediction engine 118 translates an output of the machine learning model 124 into the predicted power output 132, e.g., by scaling the output of the machine learning model 124 and/or adding an offset to the output of the machine learning model 124. In some embodiments, the power output prediction engine aggregates the output of two or more machine learning models 124 to provide an aggregate power prediction for systems with multiple blocks of power generation devices 106.

In some embodiments, the power output prediction engine 118 initiates one or more actions based on the predicted power output 132 of the power generation device 106. In some embodiments, the power output prediction engine 118 transmits a message including the predicted power output 132 of the power generation device 106. The power output prediction engine 118 can transmit the message, e.g., to an administrator or to a device or service that is configured to use the predicted power output 132. In some embodiments, the power output prediction engine 118 logs the predicted power output 132, e.g., including at least part of the data sample 114, the output of the machine learning model 124, an identifier of the power generation device 106, and/or a timestamp of the data sample 114. In some embodiments, the power output prediction engine 118 operates one or both of a second power generation device 106 or a power load device, wherein the operating is based on the predicted power output of the first power generation device. For example, if the power output of the power generation device 106 is below a predicted power output 132 in an MPPG mode, the power output prediction engine 118 can activate a second power generation device 106 to provide supplemental power and/or disable a power load to avoid exhausting the supplied power.

In some embodiments, the power output prediction engine 118 generates a predicted power output 132 of the power generation device 106 at a future point in time (e.g., a prediction of power output tomorrow based on a weather forecast received from the weather data source 304). Further, the power output prediction engine 118 can transmit the predicted power output 132 to a solar generation forecast module 402, which can use the predicted power output 132 in operations such as resource allocation and scheduling.

In some embodiments, the power output prediction engine 118 compares the predicted power output 132 of the power generation device 106 and a measured power output of the power generation device 106. For example, the power output prediction engine 118 can perform the comparison to determine whether the power generation device 106 is operating in an MPPG mode. If the predicted power output 132 of the power generation device 106 matches the measured power output of the power generation device 106, the power output prediction engine 118 can record an indication that the power generation device 106 is operating in an MPPG mode. If the predicted power output 132 of the power generation device 106 is above the measured power output of the power generation device 106, the power output prediction engine 118 can record an indication that the power generation device 106 is operating in a non-MPPG mode. Further, the power output prediction engine 118 can generate an alert by notifying an alerting system 404 regarding the non-MPPG mode of the power generation device 106, such as a request for diagnosis, maintenance, and/or replacement of power generation device 106. if the predicted power output 132 of several power generation devices 106 do not match the measured power output of the power generation devices 106, the power output prediction engine 118 can determine a possible occurrence of drift of the machine learning model 124, and can request an update of the training data set 112 and/or a retraining of the machine learning model 124.

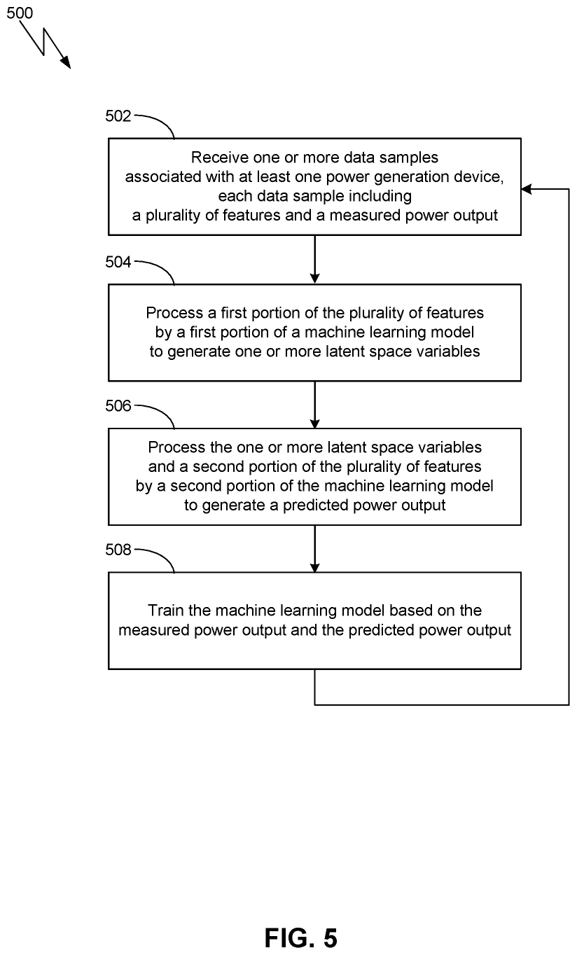

FIG. 5 is a flow diagram of method steps for training the machine learning model of FIGS. 1-3 to predict power output of power generation devices, according to one or more embodiments. At least some of the method steps could be performed, for example, by the machine learning trainer 116 of FIG. 1 or FIG. 3. Although the method steps are described with reference to FIGS. 1-3, persons skilled in the art will understand that any system may be configured to implement the method steps, in any order, in other embodiments.

As shown, at step 502, the machine learning trainer receives one or more data samples associated with at least one power generation device. Each data sample includes plurality of features of the power generation device and a measured power output. For example, the plurality of features can include ambient temperature, cloud coverage, solar irradiance (such as a solar zenith angle), and time of day. The machine learning trainer can receive the plurality of features and store them as one or more vectors in association with the measured power output.

At step 504, the machine learning trainer processes a first portion of the plurality of features by a first portion of a machine learning model. The first portion of the machine learning model generates one or more latent space variables. In various embodiments, the latent space variables can correspond to weather features, such as an ambient temperature feature and cloud cover feature. In some embodiments, the first portion of the machine learning model includes an encoder that generates a latent space encoding of the first portion of the plurality of features.

At step 506, the machine learning trainer processes the one or more latent space variables and a second portion of the plurality of features by a second portion of the machine learning model. In various embodiments, the second portion of the plurality of features represent one or both of a diffuse horizontal irradiance (DHI) solar irradiance feature or a direct normal irradiance (DNI) solar irradiance feature. The one or more latent space variables and the second portion of the plurality of features can be based on one or more physics relationships of the power generation device. The second portion of the machine learning model generates a predicted power output of the power generation device. In some embodiments, the second portion of the machine learning model includes a decoder that decodes the latent space encoding of the first portion and the second portion to determine the predicted power output of the power generation device.

At step 508, the machine learning trainer trains the machine learning model based on the measured power output and the predicted power output. In various embodiments, the machine learning trainer determines a loss function based on differences between the measured power output and the predicted power output for the one or more data samples of a training data set. Based on the loss function, the machine learning trainer updates the weights and/or biases of neurons of the first portion and/or the second portion of the machine learning model to reduce the differences. In some embodiments, the machine learning trainer returns to step 502 to continue the training of the machine learning model until the loss function is within an acceptable loss threshold.

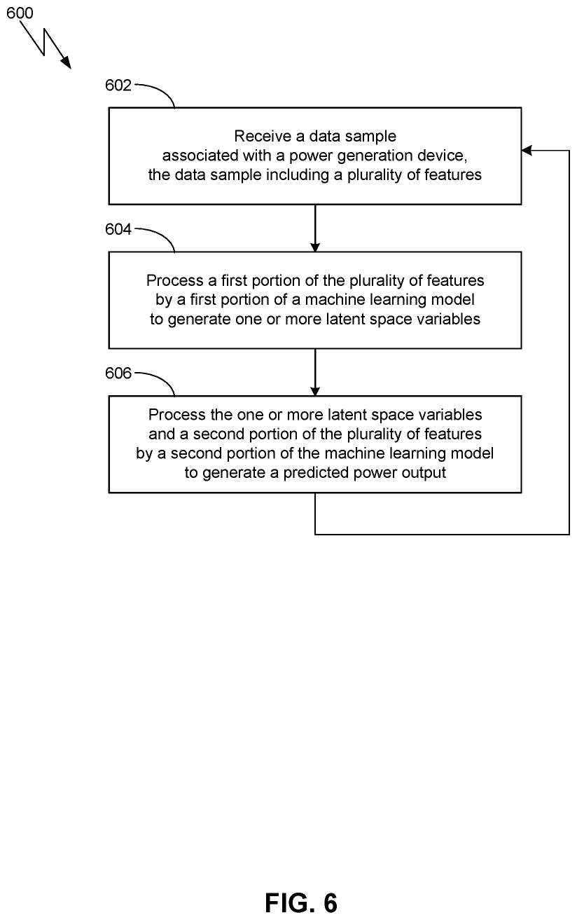

FIG. 6 is a flow diagram of method steps for using the trained machine learning model of FIGS. 1-4 to predict a power output of a power generation device, according to one or more embodiments. At least some of the method steps could be performed, for example, by the power output prediction engine 118 of FIG. 1 or FIG. 3. Although the method steps are described with reference to FIGS. 1-3, persons skilled in the art will understand that any system may be configured to implement the method steps, in any order, in other embodiments.

As shown, at step 602, the power output prediction engine receives a data sample associated with a power generation device. The data sample includes a plurality of features of the power generation device. For example, the plurality of features can include ambient temperature, cloud coverage, solar irradiance (such as a solar zenith angle), and time of day. The machine learning trainer can receive the plurality of features and store them as one or more vectors.

At step 604, the power output prediction engine processes a first portion of the plurality of features by a first portion of a machine learning model. The first portion of the machine learning model generates one or more latent space variables. In various embodiments, the latent space variables can correspond to weather features, such as an ambient temperature feature and a cloud cover feature. In some embodiments, the first portion of the machine learning model includes an encoder that generates a latent space encoding of the first portion of the plurality of features.

At step 606, the power output prediction engine processes the one or more latent space variables and a second portion of the plurality of features by a second portion of the machine learning model. In various embodiments, the second portion of the plurality of features includes one or both of a diffuse horizontal irradiance (DHI) solar irradiance feature or a direct normal irradiance (DNI) solar irradiance feature. The one or more latent space variables and the second portion of the plurality of features can be based on one or more physics relationships of the power generation device. The second portion of the machine learning model generates a predicted power output of the power generation device. In some embodiments, the second portion of the machine learning model includes a decoder that decodes the latent space encoding of the first portion and the second portion to determine the predicted power output of the power generation device. In some embodiments, the power output prediction engine initiates further actions based on the predicted power output, such as updating a solar generation forecast, generating one or more alerts, or initiating a retraining of the machine learning model. In some embodiments, the power output prediction engine returns to step 602 to receive and process additional data sample and to generate additional predictions of power output.

In sum, machine learning models are disclosed in which predictions of power output are based on one or more physics relationships of a power generation device. A power output prediction engine receives a set of data samples associated with at least one power generation device. Each data sample includes a plurality of features, such as ambient temperature, cloud cover, solar irradiance, or the like. For each of the one or more data samples, the power output prediction engine processes a first portion of the plurality of features of the data sample by a first portion of a machine learning model to generate one or more latent space variables. The one or more latent space variables and a second portion of the plurality of features of the data sample are based on one or more physics relationships of the power generation device. The power output prediction engine processes the one or more latent space variables and the second portion of the plurality of features by a second portion of the machine learning model to generate a prediction of a power output of the at least one power generation device.

At least one technical advantage of the disclosed techniques is the improved accuracy of power output predictions by machine learning models. For example, by processing a latent space variable encoding of a first portion of the plurality of features together with a second portion of the plurality of features, the power output prediction engine can process the plurality of features based on one or more physics relationships of the power generation device. The power output prediction engine can therefore generate more accurate predictions of power output of the power generation devices. Based on the predicted power output and a measured power output of a power generation device, an alerting system can determine whether the power generation device is operating in a maximum power point generation (MPPG) mode. This determination can trigger diagnostic or maintenance operations to restore the power generation device to a maximum power point generation mode. As another advantage, the machine learning model can generate accurate predictions of predicted power output, which can inform projections and schedules of power supply, demand, and sharing. These technical advantages provide one or more technological improvements over prior art approaches.
1. In some embodiments, a computer-implemented method comprises receiving one or more data samples associated with at least one power generation device, each data sample including a plurality of features and a measured power output of the at least one power generation device; processing a first portion of the plurality of features by a first portion of a machine learning model to generate one or more latent space variables; processing the one or more latent space variables and a second portion of the plurality of features by a second portion of the machine learning model to generate a predicted power output of the at least one power generation device; and training the machine learning model based on the measured power output and the predicted power output.
2. The computer-implemented method of clause 1, wherein the one or more latent space variables and the second portion of the plurality of features are based on one or more physics relationships of the at least one power generation device.
3. The computer-implemented method of clauses 1 or 2, further comprising retraining the machine learning model based on one or more updated data samples.
4. The computer-implemented method of any of clauses 1-3, further comprising retraining the machine learning model based on an updated configuration of one or both of the first portion of the machine learning model or the second portion of the machine learning model.
5. In some embodiments, a computer-implemented method comprises receiving one or more data samples associated with at least one power generation device, each data sample including a plurality of features; processing a first portion of the plurality of features by a first portion of a machine learning model to generate one or more latent space variables; and processing the one or more latent space variables and a second portion of the plurality of features by a second portion of the machine learning model to generate a predicted power output of the at least one power generation device.
6. The computer-implemented method of clause 5, wherein the one or more latent space variables and the second portion of the plurality of features are based on one or more physics relationships of the at least one power generation device.
7. The computer-implemented method of clauses 5 or 6, further comprising inputting, to the second portion of the machine learning model, a concatenation of the one or more latent space variables and the second portion of the plurality of features.
8. The computer-implemented method of any of clauses 5-7, further comprising scaling, by a scaling parameter, one or both of the one or more latent space variables or the second portion of the plurality of features.
9. The computer-implemented method of clause 8, further comprising inputting, to the second portion of the machine learning model, a concatenation of (a) one or both of the one or more latent space variables or the second portion of the plurality of features and (b) the scaled one or both of the one or more latent space variables or the second portion of the plurality of features.
10. The computer-implemented method of any of clauses 5-9, further comprising masking an output of the second portion of the machine learning model based on a mask parameter, wherein the mask parameter is based on a time of day associated with the plurality of features.
11. The computer-implemented method of any of clauses 5-10, further comprising clipping an output of the second portion of the machine learning model based on a clipping parameter, wherein the clipping parameter is based on a power output maximum.
12. The computer-implemented method of any of clauses 5-11, further comprising transmitting a message including the predicted power output of the at least one power generation device.
13. The computer-implemented method of any of clauses 5-12, further comprising generating an alert based on the predicted power output of the at least one power generation device and one or more alert thresholds.
14. In some embodiments, one or more non-transitory computer-readable media store instructions that, when executed by one or more processors, cause the one or more processors to perform the steps of receiving one or more data samples associated with at least one power generation device, each data sample including a plurality of features; processing a first portion of the plurality of features by a first portion of a machine learning model to generate one or more latent space variables; and processing the one or more latent space variables and a second portion of the plurality of features by a second portion of the machine learning model to generate a predicted power output of the at least one power generation device.
15. The one or more non-transitory computer-readable media of clause 14, wherein the one or more latent space variables and the second portion of the plurality of features are based on one or more physics relationships of the at least one power generation device.
16. The one or more non-transitory computer-readable media of clauses 14 or 15, wherein the instructions, when executed by the one or more processors, further cause the one or more processors to input, to the second portion of the machine learning model, a concatenation of the one or more latent space variables and the second portion of the plurality of features.
17. The one or more non-transitory computer-readable media of any of clauses 14-16, the instructions, when executed by the one or more processors, further cause the one or more processors to scale, by a scaling parameter, one or both of the one or more latent space variables or the second portion of the plurality of features.
18. The one or more non-transitory computer-readable media of clause 17, wherein the instructions, when executed by the one or more processors, further cause the one or more processors to input, to the second portion of the machine learning model, a concatenation of (a) one or both of the one or more latent space variables or the second portion of the plurality of features and (b) the scaled one or both of the one or more latent space variables or the second portion of the plurality of features.
19. The one or more non-transitory computer-readable media of any of clauses 14-18, wherein the instructions, when executed by the one or more processors, further cause the one or more processors to mask an output of the second portion of the machine learning model based on a mask parameter, wherein the mask parameter is based on a time of day associated with the plurality of features.
20. In some embodiments, a system comprises a memory that stores instructions, and a processor that is coupled to the memory and, when executing the instructions, is configured to receive one or more data samples associated with at least one power generation device, each data sample including a plurality of features; process a first portion of the plurality of features by a first portion of a machine learning model to generate one or more latent space variables; and process the one or more latent space variables and a second portion of the plurality of features by a second portion of the machine learning model to generate a predicted power output of the at least one power generation device.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
receiving one or more data samples associated with at least one power generation device, each data sample including a plurality of features and a measured power output of the at least one power generation device;
processing a first portion of the plurality of features by a first portion of a machine learning model to generate one or more latent space variables;
processing the one or more latent space variables and a second portion of the plurality of features by a second portion of the machine learning model to generate a predicted power output of the at least one power generation device; and
training the machine learning model based on the measured power output and the predicted power output.

2. The computer-implemented method of claim 1, wherein the one or more latent space variables and the second portion of the plurality of features are based on one or more physics relationships of the at least one power generation device.

3. The computer-implemented method of claim 1, further comprising retraining the machine learning model based on one or more updated data samples.

4. The computer-implemented method of claim 1, further comprising retraining the machine learning model based on an updated configuration of one or both of the first portion of the machine learning model or the second portion of the machine learning model.

5. A computer-implemented method, comprising:
receiving one or more data samples associated with at least one power generation device, each data sample including a plurality of features;
processing a first portion of the plurality of features by a first portion of a machine learning model to generate one or more latent space variables; and
processing the one or more latent space variables and a second portion of the plurality of features by a second portion of the machine learning model to generate a predicted power output of the at least one power generation device.

6. The computer-implemented method of claim 5, wherein the one or more latent space variables and the second portion of the plurality of features are based on one or more physics relationships of the at least one power generation device.

7. The computer-implemented method of claim 5, further comprising inputting, to the second portion of the machine learning model, a concatenation of the one or more latent space variables and the second portion of the plurality of features.

8. The computer-implemented method of claim 5, further comprising scaling, by a scaling parameter, one or both of the one or more latent space variables or the second portion of the plurality of features.

9. The computer-implemented method of claim 8, further comprising inputting, to the second portion of the machine learning model, a concatenation of (a) one or both of the one or more latent space variables or the second portion of the plurality of features and (b) the scaled one or both of the one or more latent space variables or the second portion of the plurality of features.

10. The computer-implemented method of claim 5, further comprising masking an output of the second portion of the machine learning model based on a mask parameter, wherein the mask parameter is based on a time of day associated with the plurality of features.

11. The computer-implemented method of claim 5, further comprising clipping an output of the second portion of the machine learning model based on a clipping parameter, wherein the clipping parameter is based on a power output maximum.

12. The computer-implemented method of claim 5, further comprising transmitting a message including the predicted power output of the at least one power generation device.

13. The computer-implemented method of claim 5, further comprising generating an alert based on the predicted power output of the at least one power generation device and one or more alert thresholds.

14. One or more non-transitory computer-readable media storing instructions that, when executed by one or more processors, cause the one or more processors to perform the steps of:
receiving one or more data samples associated with at least one power generation device, each data sample including a plurality of features;
processing a first portion of the plurality of features by a first portion of a machine learning model to generate one or more latent space variables; and
processing the one or more latent space variables and a second portion of the plurality of features by a second portion of the machine learning model to generate a predicted power output of the at least one power generation device.

15. The one or more non-transitory computer-readable media of claim 14, wherein the one or more latent space variables and the second portion of the plurality of features are based on one or more physics relationships of the at least one power generation device.

16. The one or more non-transitory computer-readable media of claim 14, wherein the instructions, when executed by the one or more processors, further cause the one or more processors to input, to the second portion of the machine learning model, a concatenation of the one or more latent space variables and the second portion of the plurality of features.

17. The one or more non-transitory computer-readable media of claim 14, the instructions, when executed by the one or more processors, further cause the one or more processors to scale, by a scaling parameter, one or both of the one or more latent space variables or the second portion of the plurality of features.

18. The one or more non-transitory computer-readable media of claim 17, wherein the instructions, when executed by the one or more processors, further cause the one or more processors to input, to the second portion of the machine learning model, a concatenation of (a) one or both of the one or more latent space variables or the second portion of the plurality of features and (b) the scaled one or both of the one or more latent space variables or the second portion of the plurality of features.

19. The one or more non-transitory computer-readable media of claim 14, wherein the instructions, when executed by the one or more processors, further cause the one or more processors to mask an output of the second portion of the machine learning model based on a mask parameter, wherein the mask parameter is based on a time of day associated with the plurality of features.

20. A system, comprising:
a memory that stores instructions, and
a processor that is coupled to the memory and, when executing the instructions, is configured to:
receive one or more data samples associated with at least one power generation device, each data sample including a plurality of features;
process a first portion of the plurality of features by a first portion of a machine learning model to generate one or more latent space variables; and
process the one or more latent space variables and a second portion of the plurality of features by a second portion of the machine learning model to generate a predicted power output of the at least one power generation device.
